(19) United States
(12) Patent Application Publication
(10) Pub. No.: US 2015/0012358 A1
(43) Pub. Date: Jan. 8, 2015

(54) PERSONALIZED, REAL TIME, OFFER OR PROMOTION, NEWS, AND GENERAL INFORMATION DELIVERY SYSTEM, TO A USER OR CLIENT, USING PRECISE GEO-LOCALIZING TECHNOLOGIES

(71) Applicant: IZIT SPA, Santiago (CL)

(72) Inventor: Marcos Almendras Riesco, Santiago (CL)

(73) Assignee: IZIT SPA, Santiago (CL)

(21) Appl. No.: 14/322,431

(22) Filed: Jul. 2, 2014

(30) Foreign Application Priority Data
Jul. 3, 2013 (CL) 2013-01957

(51) Int. Cl. G06Q 30/02

(52) U.S. Cl. CPC G06Q 30/0259; G06Q 30/0267
USPC 705/14.57

(57) ABSTRACT

System for delivery of promotions, offers, news, or general information, personalized, in real time, to a user or client, allowing to increase concretion of sales stimulated by specific offers or promotions, the system comprising the following elements:
a. a configuration platform allowing generating offers, ads, or promotions;
b. a mobile device allowing the user or client to receive offers or promotions;
c. localization means, allowing to detect the location of the user inside a store with sufficient precision, in order to the offers or promotions sent to the user are related to the products in close proximity to the user or client in a determined moment; and
d. a method for producing promotions, ads or messages to be sent to the mobile device.

### TECHNICAL FIELD

The present invention is related to a commercial promotion system specifically directed to consumers or users, wherein generation of an offer is produced within a store, preferably a large retail store or supermarket, and more specifically, the offer is produced when the user is near a place where a specific product is located within said store.

### BACKGROUND

In retail there are many issues that require improvement. Of these issues, the profitability of displayed products in the interior of retail stores stands out.

There are many measurements for defining and quantifying profitability that sought to obtain a detailed description of sales of each product displayed in the interior of the retail store. Currently there are promotion programs directed to increase sales volumes through promotions or offers, nevertheless, said promotion programs present several problems that finally translate in a very low sale conversion index, lower than 10%, i.e. for each 10 offers or promotions, only one is finally transformed in a closed sale by the user or consumer benefited from the offer or promotion.

The system of the present invention is directed to solve the problem of low sale conversion indexes, increasing them.

### PRIOR ART

Patent application US2012095822 describes a system and method for delivering promotions and collect or redeem them in a safe manner. This application specifies the use of a smartphone, wherein said phone is communicated with a server and a database through a software program (application) and a network connection. It is described that each bidder is provided with a device able to send offers with a unique identifier changing with each offer sent, and also registering the time at which the offer is made. The way to collect or redeem the prize or offer is made at the point-of-sale (POS) wherein the application uses the smartphone's camera to register a code. The application coordinates the information of the code plus additional information, which is sent to the central server, wherein the data is authenticated.

Patent application US2012173337 describes a system and method for delivering information to a mobile device based on its location. It is based on a series of access points, connected to a network, detecting the location of the mobile device, and at the same time can send information to said device. The information sent is obtained from information providers connected to the network.

International patent application WO2010128980 describes a system and/or method for sending commercial information to a mobile device, in particular, a cellular phone. It is described a selection of vendors based on their distance or if they are in a covered area or not, from a transmitting antenna (base station, cell). Unlike this document, the present invention is directed to promote commercial offers to potential clients inside a store, thus its application and implementation differs considerably.

International patent application WO2011017286 describes a method for offering publicity based in the comments or messages available in social networks. The possibility that said commercial or publicity offers can be based in localization of the user to whom the message would be directed is mentioned. Unlike this document, the present invention is directed to offer specific offers to users located inside a particular store.

Patent application US2012054001 describes a publicity method using a virtual “scratchcard”. The scratchcard is shown in the mobile device, when the device is physically close to a specific zone. The method defines 2 zones, a first wider zone, allowing displaying of the scratchcard in the device, and a second closer zone, allowing to the user to “scrape” the scratchcard and having access to the offer. This document differs from the present invention, since it is directed to the way in which the offer is presented to the user. On the contrary, the present invention is directed to find a solution presenting offers to a particular user inside a specific store.

Patent application US2012101888 describes a manner to deliver content to a mobile device through a network. In the first place, it is required to obtain the localization of the mobile device and identify an object using the mobile device. Said information is transmitted to a central server providing to the mobile device more information about the article. The description found in this document differs from the present invention, since this document requires the user to identify a product. On the contrary, the present invention requires a definition of a zone inside a store, and when the user (Smartphone) is detected in close distance to the zone, the offer is made.

Patent application US2012109752 describes promotion (marketing campaigns) to a consumer, using the location indicated in social networks by the user (check-ins). Based on the information collected from many social networks, a central server, after processing the information and using user profiles, sends publicity campaigns specific to the user, whom through an action, completes the marketing campaign. This document greatly differs from the present invention, since it requires that the user performs an action of registering in a particular store. On the contrary, the present invention is directed to retail stores or supermarkets, wherein determining the location of the user is made automatically.

Patent application US2012130817 describes a method for performing relevant offers to an individual, based on their journey patterns history. Temporal analysis of the user's movements and frequency, i.e. location, route, time of day or frequency, such as once or more times a day, once per week, once a month, or if the movement occurs at a similar time every time. On the contrary, the present invention is focused in real time offerings, and also the creation of new metrics in real time, generating dynamic promotions, in the moment when the user (smartphone) is detected inside a store.

Patent application US2012150621 describes offers delivered to a GPS-enabled device. The offers are based in the location of the device and the user profile associated to the device. The device informs its location to a server (website), search in its database the individual, and after checking the profile (if it exists) together with the location, sends offers of goods or services relevant for that location and the user profile. The use of a GPS system is not successful inside a store, therefore, the present invention greatly differs from this document, since the application of the present invention is inside stores.

International patent application WO2012094680 describes displaying of commercial ads in a mobile device through a software application. Said application is operated through a server connected to a network, such as Internet. Geographical location must be determined for delivery of commercial ads, and the server will send those ads to mobile devices close to the determined geographical zone. The user of the mobile device can receive incentives for receiving commercial ads. The present invention incorporates a mechanism to place promotions based in the behavior and consume history of a user, their geographical location and current interests. This allows fast determination of relevance in the search of a user, allowing matching the most relevant promotions for each user.

### SUMMARY OF THE INVENTION

The present invention is directed to provide a personalized promotion or offer system for users or clients, wherein sending of promotions or offers is made in real time, during the period of time when the user is inside a determined store.

The promotion system requires the presence of means that will allow to detect the presence of a user inside a store, in particular, the offer sent will be related to the products that are closely located to the user. This enables a new promotional channel for brands, which still has not been developed in the world.

### DETAILED DESCRIPTION OF THE INVENTION

In particular, the present invention requires for functioning geo-location for administering/distributing information and/or promotional ads or offers through mobile devices. One of the main applications is a system based in, for example, a smartphone, using geo-location technologies for automatically identifying a user or client when is inside a store, allowing to relate the displayed articles with the users or clients more prone to buy them, exactly in the moment of greater disposition to buy and when they are close to the product, improving, among other things, the shopping experience inside a store.

In parallel, the system of the invention also allows bringing the personalization of information that a client can receive from the store and brands present inside the store to a new level.

Since the present invention allows delivery of promotions or offers occurring near the products and in the exact moment when a client is buying, these promotional ads result more effective than traditional advertising mechanisms and thus will have a greater conversion rate.

Unlike traditional online advertising mechanisms, the geo-referenced ads inside stores have some unique features such as:
Increase in propensity to buy, due to the fact that a user is inside a store with a purchasing behavior.
Geo-referenced location of the user inside the store, unlike traditional online advertising digital channels, users have total control over information and/or acceptance of promotions that they receive (opt-in) from the present invention.
identification of a specific client when inside a store.
Period of purchase, defined as the specific time when a client is sensitive to receive a message during their purchase process.
Location defined as the specific geographic place inside a store or shopping area.
Generation of microsegmented ads, and exclusive for a store.

In order to determine the efficiency of the present invention, is important to collect data relative to changes that are produced in the purchase behavior of the clients, their loyalty to a store/brand, effectiveness that this new digital channel has compared to current channels and operational aspects involving the retail stores.

The most relevant metrics for advertising inside store are:

Click Through Rate (CTR):

In online advertising. CTR is a way to measure the success of a advertising campaign online. CTR is obtained dividing the number of visitors that clicked a web banner in a webpage, in this case it is the tapping of an ad sent by the system of the invention, by the number of times the ad has been seen (impressions).

Promotion Acceptance Rate (PAR):

PAR is the percentage in which a promotion is selected and accepted by a client versus the total amount of promotions sent. This indicator represents the intention to buy of a user faced with a promotion.

In-Store Conversion Rate (ISCR):

ISCR is the percentage in which an accepted promotion is effectively purchased or redeemed at the point of sale (POS).

Time in Store (TIS):

TIS indicator logs the total amount of time that a client was in a particular location from the moment that entered the fence until the exit from the fence.
Visitor frequency in a store: indicates the amount of unique visits that a user makes to a geo-referenced zone or fence.
Average changes in time in store: variation in the average time of visit of users depending on the day and time for a specific period or season.
Average changes in amount spent per visit.
Message amount (advertising ads) per user per visit: average amount of messages that a user receives entering a retail store. This rate is defined by the relevance degree that a specific promotion has for a particular user.
Inventory rotation changes based in the promotions of the store, with the objective of predicting inventory under Promotion Acceptance Rate PAR that a user has for a product.

The invention, as established, corresponds to a promotion or offer delivery system to a user in real time, wherein the delivery of promotions is made inside a store. In particular, the delivery of a promotion or an offer is made at the moment that the user is detected in a predetermined influence zone inside a store. The user will be presented with different options when notified of the offers or promotions available.

The system of the invention comprises the following elements:
a configuration platform allowing generating offers, ads, or promotion;
a mobile device allowing the user or client to receive offers or promotions;
localization means, allowing to detect the location of the user inside a store with sufficient precision, in order to the offers or promotions sent to the user are related to the products in close proximity to the user or client in a determined moment.
a method for producing promotions, ads or messages to be sent to the mobile device, wherein the method allows limiting promotions, for example, in the following elements:
   zone delimited around a specific product, which can be a dynamic zone (microzone or super-fence);
   price;
   number of users present in a delimited zone;
   bids from clients in a delimited zone, in a kind of auction of offers;
   preferences of the user;
   purchase history of the user;
   real time events, such as for example, birthdates, holydays, weather, etc.

In particular, the user profile is understood in the present invention as information relative to a particular user including, but not limited to, demographic information, such as age, sex, residence, workplace; historical information of purchases made; preferences information of interests declared by the user, for example in social networks, in search engines, etc.; social network information, such as associated friends or family members in social networks such as Facebook, Twitter, or others.

In particular, the operation of the system can be performed in many ways, depending on the advertisers or product or service providers, whom in the end will access the configuration platform allowing generation of offers, ads, or promotions.

In a particular embodiment, the configuration platform allows generating offers, ads or promotions, is configured in order to elaborate a list of personalized promotions or offers, depending on the profile of a user or client, that the promotion generation has access to.

In other embodiment, the mobile device through which the user can receive offers or promotions, allows displaying the offers or promotions, or call the attention of the user in a visual manner (graphic or text display in a screen, flashing lights of the device, etc.), auditory manner (through sounds, tones, pre recorded phrases, or phrases emitted by a voice synthesizer), or through vibration of the device.

In a more particular embodiment, the mobile device is able to detect a signal emitted by the user. In an even more particular manner, said signal can be an auditory signal, such as for example a voice command; visual, such as for example a signal that can be detected by a camera present in the mobile device; tactile, such as for example an interaction of the user with the mobile device through a keyboard or touch-sensitive screen; movement, such as for example shaking the device in a predetermined manner.

In other embodiment, the signal emitted by the user through the mobile device configures an interaction with the promotion or offer displayed in a determined moment in the mobile device. This interaction can have different consequences, such as for example, displaying more specific information related to the promotion or offer (for example, the price, discount in the price, offers opting to take an extra article in offer for the price of one duration of the offer or promotion, etc.), allowing to accept the offer or promotion, reserving the offer or promotion, discarding the offer or promotion, sharing the offer or promotion in a social communication platform (social networks), transferring the offer to a different user or client, etc.). The way in which the user interacts with the offer or promotion displayed in a determined moment can be as previously mentioned, such as for example through a visual signal (captured by a camera present in the mobile device), auditory (such as for example a voice command), movement (shaking of the device), etc.

In even other embodiment, the localization means can detect a specific user or client. In a particular manner, the localization means can comprise two modules, one that is present in the mobile device, and other that is distributed around the store. In a more particular embodiment, the localization means use wireless technologies for detecting the position of the user or client inside a store. In a specific embodiment, wireless technologies used for detecting a user or client inside a store can be selected among: wireless network technologies, such as for example wireless local area network (wireless LAN, or WIFI) in any of their protocols; geo-referencing technologies using GPS, GLONASS or other geo referencing technology; wireless technologies such as Bluetooth; video-based people recognition technology; radiofrequency identification technologies (RFID); cellular telephone communication network technologies (GSM, COMA, HSPA, PDMA, UMTS, HSDPA, LTE); detection technologies using magnetic means, or combinations thereof.

In a more specific embodiment, the mobile device can incorporate the functions of receiving offers or promotions and at the same time, helping in the location of the user or client inside a store.

In a more specific embodiment, the mobile device corresponds to a smartphone.

In a particular embodiment, the localization means distributed inside the store allow defining specific delimited zones. Said specific delimited zones allow to define further particular zones inside of which there are previously classified identified products. Said previously classified identified products could fail in general classifications, in order to allow the configuration platform to generate offers, ads, or promotions aware of the location of a user inside a specific defined zone, allowing to personalize offers or promotions in order to have them related to the category to which the zone corresponds.

In other embodiment of the invention, delimited zones can be microzones or “super fences”, wherein said microzone is associated to the capacity of establishing different parameters for each of said microzones, and wherein also other evaluation metrics are linked to microzones in order to enable a promotional channel.

In a particular embodiment of the invention, the method to produce promotions or ads or messages to be sent to the mobile device, uses information from at least one source of information selected among 1) location of a user inside a particular microzone or “super fence”; 2) user profile; 3) offers, promotions, or messages elaborated for a particular company or institution.

In particular, the method for elaborating promotions or ads or messages to be sent to the mobile device considers the 1) location of the user inside a microzone or “super fence” in order to coordinate said information with the 2) user profile, comprising relevant information of the user, such as for example demographic information, purchase history, or information that said user provided indicating interest, among others; for crossing these two sources of information with 3) offers, promotions or messages elaborated by a particular company or institution, that match said crossing.

In a particular embodiment, a microzone or “super fence” defined inside a retail store, defines a zone wherein a determined product is displayed or offered. If the system for elaborating promotions or ads or messages detects a particular user in said zone, and if the user profile indicates that said user would have a potential interest for one of the products displayed in said microzone or “super fence”, then, the system will search among the current offers, promotions, or messages available associated to said microzone or “super fence” that would result potentially interesting for the user present in said microzone or “super fence”, triggering the delivery of said offers, promotions or messages to the mobile device of the user present in said microzone or “super fence”.

For example, if a user is detected in a zone defined as “electronic products”, then the offer generator would personalize a promotion directed to electronic articles, considering the known profile of the specific user. This indication is only given as an example, and in no manner should be understood as a limitation to the scope of the invention, wherein many other categories can be defined, such as for example, and again without the intention of limiting the scope of the invention, a cleaning supplies zone, toiletry articles zone, vegetables zone, meat zone, fish zone, grocery zone, non-perishable products zone, beverages zone, alcoholic drinks zone, bakery zone, household items zone, bathroom items zone, bed and linens zone, healthy food zone, pet food zone, car parts zone, camping items zone, plants and garden zone, etc.

In a more particular embodiment, localization means can define sub-zones or microzones inside more general zones, wherein the microzone or “super fence” is defined by the closeness of more specific products. For example, many sub-zones can be defined in the “electronic products” zone, such as for example televisions zone, mobile phone zone, audio equipment zone, home appliances zone, etc. In a more particular embodiment, even more specific zones can be defined inside sub-zones. This sub-classification can be made as specific as needed, to the point of identifying the user or client when is in front of a specific product.

Combination of zones and sub-zones, each one classified in different categories, and wherein the configuration platform allows generating offers, ads or promotions, has access to the information of which products are located in which particular zone, allowing to send specific offers or promotions directed to a user or client located very close to a particular product. In a particular embodiment, the zones identified by the localization means allow defining zones of at least 50 m², 40 m², 30 m², 20 m², 10 m², 5 m². More specifically, localization means allow to define sub-zones of 40 m², 30 m², 20 m², 10 m², 5 m², 2 m², 1 m², 0.5 m².

### Examples of Application

The following example corresponds to a pilot of the system of the invention, and was performed in an important mall center in Chile, during the weekend of mother's day, between may 9th to 12th 2013.

This shopping mall is the largest in South America, with a surface of 268 thousand square meters, housing over 300 stores, 5 big retail stores, and 6 floors.

To exemplify the invention, inside the shopping mall GPS-based localization means, access point networks, and ultrasound systems were installed.

The localization means were calibrated using a smartphone as a mobile device, wherein the smartphone was WIFI-, GPS-, and Ultrasound-enabled.

Based on calibration, it was possible to define zones inside the shopping mall such as: external periphery zone, common inner zone (hallways, not including stores), and 25 stores participating in the pilot.

During the 4 days of the pilot, 2 booth-stands were installed in different places in the first floor inviting users to test the application. The application was finally distributed among 1,045 volunteer users, installing the application in their mobile phones, during the 4 days for the pilot.

The application worked as an interface sending information calibrated according to the exact location of the user in a determined moment to the promotion generator, at the same time allowing to display in the mobile device the offers or promotions that the promotion generator will send, triggered by the user profile as well as the location of the user inside the shopping mall or a particular store in a specific moment. Selection of each promotion is made as a result of the relevance that this would have for a specific user.

2 types of promotions were designed: gifts and discounts. Each promotion implemented should be exclusive, i.e., unique for the channel used by the present invention and should not be visible to the users in the stores.

The promotions of each store were configured in 2 zones of the shopping mall. The first zone was common spaces or hallways inside the shopping mall, and the second area were inside each of the participant stores. The objective of this configuration is that once a user is detected entering the shopping mall, a promotion or ad is sent, inviting the user to visit a specific store. Once the user entered the specific store, a second promotion of the specific store is sent.

The following table summarizes the main indicators recorded for some of the campaigns implemented during the pilot:

| | | Pro- | | | Converted |
|---|---|---|---|---|---|
| Client/ | | motions | Taps | Accepted | (Conversion |
| Brand | Promotion | or ads sent | (CTR) | (PAR) | Rate) |
| Shopping | — | 10,977 | 6.877 | 1.258 | 677 |
| mall | | | 63% | 11.46% | 6.17% |
| (TOTAL) | | | | | |
| Client 1 | Sampling | 244 | 178 | 76 | 62 |
| | | | 73% | 31.15% | 25.41% |
| Client 2 | Free pillow | 107 | 83 | 75 | 60 |
| | | | 78% | 70.09% | 56.07% |
| Client 3 | 2 boxers | 265 | 196 | 54 | 19 |
| | with any | | 74% | 20.38% | 7.17% |
| | other | | | | |
| | purchase | | | | |
| Client 4 | Scarf at a | 17 | 14 | 9 | 8 |
| | preferential | | 82% | 52.94% | 47.06% |
| | price | | | | |
| Client 5 | Yogurt ice- | 224 | 128 | 7 | 1 |
| | cream maker | | 57% | 3.13% | 0.45% |
| Client 6 | Daily journal | 473 | 307 | 33 | 2 |
| | as a gift with | | 65% | 6.98% | 0.42% |
| | a purchase | | | | |

As can be observed, the system of the invention allows increasing purchase concretion of a product in an average of 6.17%. Also, it is appreciated that for more specific purchases conversions of 0.42% are obtained in the worst cases. The best cases were obtained with gifts, nevertheless, comparing gift ads with other types of gifts, similar CTRs are observed.

### INDUSTRIAL APPLICATION

The present invention has application in the field of retail store sales, wherein the invention allows increasing the purchase concretion rates, stimulated by specific offer or promotions, allowing at the same time to obtain benefits such as protecting the user privacy, reducing the amount of unsolicited offers (spam) and improving the shopping experience of the user.

1. System for delivery of promotions, offers, news, or general information, personalized, in real time, to a user or client, allowing to increase concretion of sales stimulated by specific offers or promotions, the system comprising the following elements:
a. a configuration platform allowing generating offers, ads, or promotions;
b. a mobile device allowing the user or client to receive offers or promotions;
c. localization means, allowing to detect the location of the user inside a store with sufficient precision, in order to the offers or promotions sent to the user are related to the products in close proximity to the user or client in a determined moment; and
d. a method for producing promotions, ads or messages to be sent to the mobile device.

2. System for delivery of promotions, offers, news, or general information, according to claim 1, wherein the configuration platform allows generating offers, ads or promotions, is configured in order to elaborate a list of personalized promotions or offers, depending on the profile of a user or client, that the promotion generation has access to.

3. System for delivery of promotions, offers, news, or general information, according to claim 1, wherein the mobile device through which the user can receive offers or promotions, allows displaying the offers or promotions, or call the attention of the user.

4. System for delivery of promotions, offers, news, or general information, according to claim 3, wherein the attention of the user is called in a visual manner (graphic or text display in a screen, flashing lights of the device.

5. System for delivery of promotions, offers, news, or general information, according to claim 3, wherein the attention of the user is called in an auditory manner (through sounds, tones, pre-recorded phrases, or phrases emitted by a voice synthesizer), or through vibration of the device.

6. System for delivery of promotions, offers, news, or general information, according to claim 1, wherein the mobile device is able to detect a signal emitted by the user.

7. System for delivery of promotions, offers, news, or general information, according to claim 6, wherein the signal can be an auditory signal.

8. System for delivery of promotions, offers, news, or general information, according to claim 6, wherein the signal can be visual.

9. System for delivery of promotions, offers, news, or general information, according to claim 6, wherein the signal can be tactile.

10. System for delivery of promotions, offers, news, or general information, according to claim 6, wherein the signal can be a movement.

11. System for delivery of promotions, offers, news, or general information, according to claim 6, wherein the signal emitted by the user through the mobile device configures an interaction with the promotion or offer displayed in a determined moment in the mobile device.

12. System for delivery of promotions, offers, news, or general information, according to claim 11, wherein the interaction allows to display more specific information related to the promotion or offer.

13. System for delivery of promotions, offers, news, or general information, according to claim 11, wherein the interaction allows accepting the offer or promotion, reserving the offer or promotion, discarding the offer or promotion, sharing the offer or promotion in a social communication platform (social networks), transferring the offer to a different user or client, etc.), or combinations if these actions.

14. System for delivery of promotions, offers, news, or general information, according to claim 1, wherein the localization means can detect a specific user or client.

15. System for delivery of promotions, offers, news, or general information, according to claim 14, wherein the localization means comprise two modules, one that is present in the mobile device, and other that is distributed around the store.

16. System for delivery of promotions, offers, news, or general information, according to claim 1, wherein the localization means use wireless technologies for detecting the position of the user or client inside a store.

17. System for delivery of promotions, offers, news, or general information, according to claim 16, wherein the wireless technologies used for detecting a user or client inside a store can be selected among: wireless network technologies, such as for example wireless local area network (wireless LAN, or WIFI) in any of their protocols; geo-referencing technologies using GPS, GLONASS or other geo-referencing technology; wireless technologies such as Bluetooth, video-based people recognition technology; radiofrequency identification technologies (RFD); cellular telephone communication network technologies (GSM, CDMA; HSPA, PDMA, UNITS, HSDPA, LTE); detection technologies using magnetic means, or combinations thereof.

18. System for delivery of promotions, offers, news, or general information, according to claim 1, wherein the mobile device incorporates the functions of receiving offers or promotions and at the same time, helping in the location of the user or client inside a store.

19. System for delivery of promotions, offers, news, or general information, according to claim 1, wherein the mobile device corresponds to a smartphone.

20. System for delivery of promotions, offers, news, or general information, according to claim 15, wherein the localization means distributed inside the store allow defining specific delimited zones.

21. System for delivery of promotions, offers, news, or general information, according to claim 20, wherein delimited zones allow to define further particular zones inside of which there are previously classified identified products.

22. System for delivery of promotions, offers, news, or general information, according to claim 21, wherein delimited zones can be microzones or “super fences”, wherein said microzone is associated to the capacity of establishing different parameters for each of said microzones, and wherein also other evaluation metrics are linked to microzones in order to enable a promotional channel.

23. System for delivery of promotions, offers, news, or general information, according to claim 22, wherein microzone or “super fence” defined inside a retail store, defines a zone wherein a determined product is displayed or offered.

24. System for delivery of promotions, offers, news, or general information, according to claim 20, wherein the zones identified by the localization means allow defining zones of at least 50 m².

25. System for delivery of promotions, offers, news, or general information, according to claim 22, wherein the microzones are of at least 40 m².

26. System for delivery of promotions, offers, news, or general information, according to claim 1, wherein the method to produce promotions or ads or messages to be sent to the mobile device, uses information from at least one source of information selected among 1) location of a user inside a particular microzone or “super fence”; 2) user profile; 3) offers, promotions, or messages elaborated for a particular company or institution.

27. System for delivery of promotions, offers, news, or general information, according to claim 26, wherein the method for elaborating promotions or ads or messages to be sent to the mobile device considers the 1) location of the user inside a microzone or “super fence” in order to coordinate said information with the 2) user profile, for crossing these two sources of information with 3) offers, promotions or messages elaborated by a particular company or institution, that match said crossing.
